(19) United States
(12) Patent Application Publication
(10) Pub. No.: US 2009/0295333 A1
(43) Pub. Date: Dec. 3, 2009

(54) METHOD OF DETERMINING STATE OF CHARGE OF BATTERY OF VEHICLE

(75) Inventor: Ki Seon Ryu, Seoul (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/276,738

(22) Filed: Nov. 24, 2008

(30) Foreign Application Priority Data
Jun. 2, 2008 (KR) 10-2008-0051443

(51) Int. Cl. H02J 7/00; H02J 7/04

(52) U.S. Cl. 320/134; 320/162

(57) ABSTRACT

The State Of Charge (SOC) of a battery of a vehicle is determined using the value of current input to the battery through a generator and the value of current output from the battery to a vehicle side. When the voltage of the battery is increased by a predetermined level or higher for a predetermined time period but the battery is not in the state of being charged through the generator, it is determined as an externally charged state attributable to an external charging device. The value of a charging current flowing through the battery is obtained during the externally charged state, and the SOC of the battery is compensated based on the value of the charging current.

### CROSS-REFERENCE TO RELATED APPLICATIONS

This application claims under 35 U.S.C. §119(a) priority to Korean Application No. 10-2008-0051443, filed on Jun. 2, 2008, the disclosure of which is incorporated herein by reference in its entirety.

### BACKGROUND

1. Technical Field

The present invention relates to a method of determining the State Of Charge (SOC) of a battery of a vehicle on the basis of values of current input to and output from the battery.

2. Background Art

A vehicle is equipped with a battery for providing electric power to various electronic devices. The battery is selectively charged using a generator, which operates in conjunction with an engine, so as to maintain a certain charge level. Here, the term “generator” includes an alternator and an electric generator.

The Electronic Control Unit (ECU) of an engine operates a generator when the SOC of a battery is not sufficient and stops the operation when the SOC is sufficient. Further, the ECU displays the SOC on an instrument cluster inside a vehicle, and provides a warning signal when the SOC is not sufficient, thereby enabling a driver to check the status of the SOC and manage accordingly.

The SOC of a battery is generally obtained by periodically measuring the value of current input from the generator to a battery and the value of current output from the battery to a vehicle side, using a sensor attached onto the battery, obtaining an increased/decreased amount of charge based on the values of the currents, and then applying variation in the amount of charge to the SOC. A resistor, called a shunt, is attached onto the sensor and is configured to measure the values of current input/output to/from the battery.

A prior art method of determining the SOC of a battery will be described with reference to FIGS. 1 and 2. FIG. 1 is a circuit diagram briefly showing a charging system to which an external charging device is not connected. When a vehicle is parked, no electric device is operated, and only a very small discharged current flows through an internal resistor 70 of the vehicle. The variation in the SOC attributable to the discharged current is obtained by applying to a stored map the voltage and temperature of a battery in a stable state. When the vehicle is in an ignition-on state, a generator 50 is not operated, so that only discharge occurs. In this case, the remaining SOC is determined by measuring the value of current which flows through a shunt 32 of a sensor 30 and then measuring an amount of decreased SOC based on the value of the current. When the engine of the vehicle is started, the generator 50 is in operation. Therefore, the value of current input to the battery 10 is measured, and the SOC is determined. That is, the SOC is calculated using only current flowing through the shunt.

FIG. 2 is a circuit diagram briefly showing a charging system to which an external charging device is connected. An external charging device 90 may be a jump, whereby a battery is jumped from another vehicle, or a separate charger. When the external charging device 90 is connected to the battery 10 in the state in which the battery is being discharged, current flows from the external charging device 90, in which voltage is higher, to the battery 10, in which voltage is lower, so that the battery is charged. However, since the inflow current does not pass through the shunt 32 but flows only between the battery 10 and the external charging device 90, the SOC of the battery 10 cannot be recognized.

That is, according to the prior art method of determining the SOC of a battery, the SOC cannot be compensated using the amount of incremental change in the SOC which is externally charged, with the result that the SOC determined by the method is lower than the actual SOC. Accordingly, excessive charge may occur, resulting in the loss of electric power and the reduction of the life span of the battery.

The above information disclosed in this the Background section is only for enhancement of understanding of the background of the invention and therefore it may contain information that does not form the prior art that is already known in this country to a person of ordinary skill in the art.

### SUMMARY OF DISCLOSURE

Accordingly, the present invention has been made keeping in mind the above problems occurring in the prior art, and an object of the present invention is to detect charging provided by an external charging device, and to compensate the SOC of a battery using the amount of incremental change in SOC.

In order to accomplish the above object, one aspect of the present invention provides a method of determining the State Of Charge (SOC) of the battery of a vehicle, including determining the SOC of a battery using the value of current input to the battery through a generator and the value of current output from the battery to a vehicle side; and when the voltage of the battery is increased by a predetermined level or higher for a predetermined time period but the battery is not in the state of being charged through the generator of the vehicle, determining that it is an externally charged state attributable to an external charging device, obtaining the value of a charging current flowing through the battery during the externally charged state, and compensating the SOC based on the value of the charging current.

Whether the battery is charged through the generator of the vehicle may be determined using the value of current flowing through a shunt of a battery sensor.

The compensation of the SOC is performed if it is determined that the battery is not in a discharged state. The determination of whether the battery is in a discharged state is made by using the value of current flowing through the shunt of the battery sensor.

The value of the charging current is obtained based on the voltage of the battery measured before the voltage is increased, the voltage of the battery in the externally charged state, and the internal resistance of the battery.

The compensation of the SOC is terminated when the voltage of the battery is decreased by a predetermined level or higher for a predetermined time period.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a circuit diagram showing a charging system to which an external charging device is not connected; and

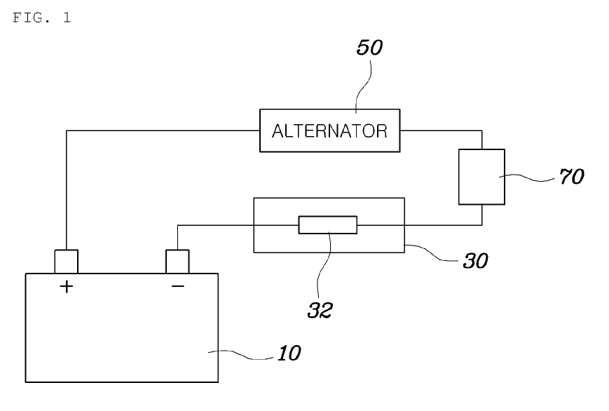

FIG. 2 is a circuit diagram showing a charging system to which an external charging device is connected; and

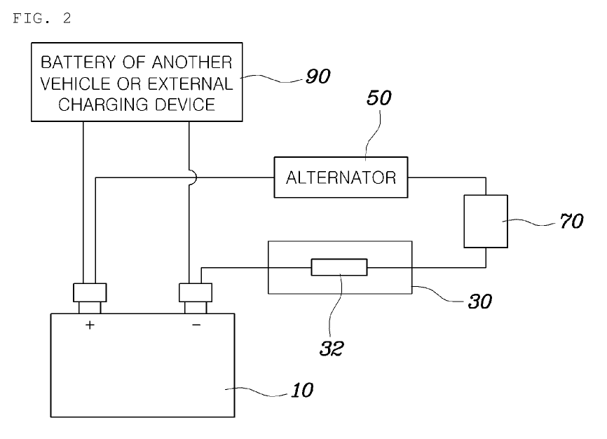

FIG. 3 is a flowchart showing a method of determining the SOC of the battery of a vehicle according to an embodiment of the present invention.

### DETAILED DESCRIPTION

Hereinafter reference will now be made in detail to various embodiments of the present invention, examples of which are illustrated in the accompanying drawings and described below.

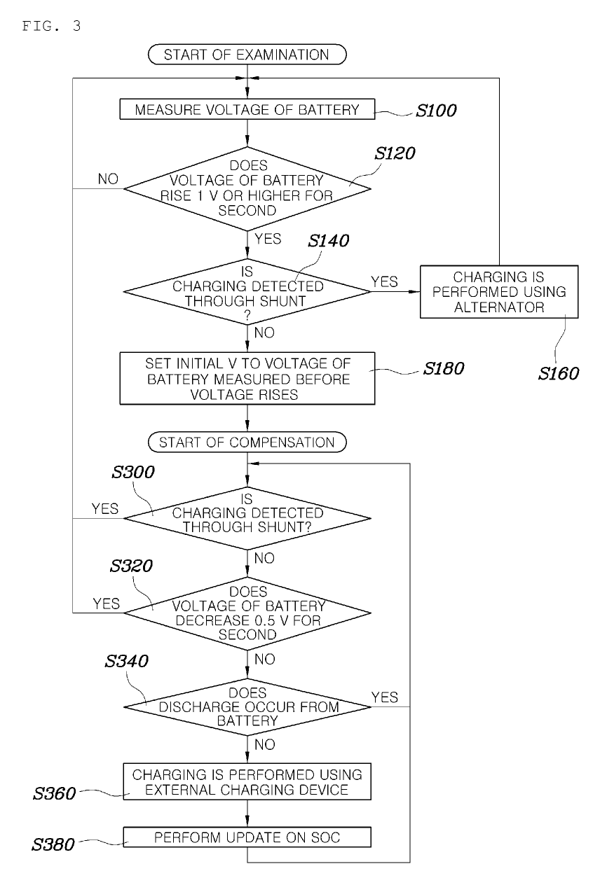

A method of determining the SOC of a battery of a vehicle according to an embodiment of the present invention will be described with reference to FIG. 3.

The SOC of a battery is determined using the value of current input to the battery through a generator and the value of current output from the battery to a vehicle side. When the voltage of the battery is increased by a predetermined level or higher for a predetermined time period but the battery is not in the state of being charged through the generator of the vehicle, it is determined that the state is an externally charged state attributable to an external charging device. The value of a charging current flowing through the battery during the externally charged state is obtained. Based on the value of the charging current, the SOC is compensated.

The definition and determination (start of examination) of the externally charged state will now be described in detail. The voltage of the battery (the potential difference between a positive terminal and a negative terminal) is measured at predetermined time intervals (for example, 1 ms) at step S100. This can be ascertained using the voltage differential between both terminals of the shunt of the battery sensor. Whether the voltage of the battery increases by a predetermined level or higher for a predetermined time period (for example, 1 V or more for a second) is determined at step S120, and whether inflow current through the shunt exists is determined at step S140. If inflow current exists, it is determined that the battery is charged by a generator at step S160.

If the voltage suddenly rises and there is no inflow current through the shunt, it is determined as an externally charged state. Here, it is preferable to record the level of the voltage obtained before the sudden voltage increase at step S180. The level of the voltage obtained before the sudden voltage increase is used to determine the SOC, as described later.

If it is determined as an externally charged state, whether to make compensation and what the magnitude of the compensation are determined (the start of compensation). Whether inflow current through a shunt exists is determined again at step S300. If the inflow current exists, it is determined that the battery is charged by the generator, so that the process returns to the initial step of determining an externally charged state. If no inflow current through the shunt exists, whether there is a voltage drop of the battery is determined at step S320. If the voltage of the battery decreases by a predetermined level or higher for a predetermined time period (for example, 0.5 V or more for a second), it is determined that the externally charged state is completed. The reason for this is that, in the case in which the charging is completed and then an external charging device becomes disconnected, a little voltage drop occurs because current flows between the battery and the load of a vehicle. If it is determined that the externally charged state has been completed, the process returns to the initial step of determining an externally charged state again.

If no inflow current through the shunt exists but outflow current through the shunt exists, it is determined as a discharged state (for example, an ignition-on state) at step S340. However, in this case, the state of discharge is not required to be compensated for since the state of discharge is detected not from the battery but from the external charging device (that is, since the electric devices of a vehicle are operated by the external charging device having a higher voltage than the battery). Meanwhile, the outflow of a small amount of current is not to be determined as a discharged state since a small amount of discharge normally exists in vehicles. The value of outflow current used to determine the discharged state is determined experimentally.

If there is no inflow nor outflow current through the shunt and the decrease of voltage is not detected, it is determined as an externally charging state at step S360, and then the SOC is compensated using the amount of incremental change in the SOC attributable to the external charging device at step S380. Since the amount of incremental change in SOC to be compensated is not obtained by measuring current flowing through the shunt, it is calculated indirectly.

For example, the value of charging current is obtained by dividing the difference between the voltage of the battery measured before a sudden voltage increase occurs at step S180 and the voltage of the battery in the externally charged state by the internal resistance of the battery, the amount of charge is obtained by performing the integration of the value of charging current over a charging time, and then the SOC is compensated on the basis of the obtained amount of charge.

Briefly, as discussed above, in the case in which the voltage of a battery is increased but a generator is not operated, it is determined as an externally charged state. In the case in which the voltage is decreased during the externally charged state, it is determined that the charging is completed. In the case in which the voltage is not decreased but discharge through a shunt is detected, compensation is not performed. The compensation is performed when the externally charged state is being maintained. The value to be compensated is calculated on the basis of the value of charging current that is obtained through the division of the difference between initial voltage and current voltage by the internal resistance of the battery.

According to the above-described methods, the overcharge of a battery can be prevented, the loss of electric power can be minimized and the life span of the battery can be increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of determining a State Of Charge (SOC) of a battery of a vehicle, comprising:
determining an SOC of a battery using a value of current input to the battery through a generator and a value of current output from the battery to a vehicle side; and
when the voltage of the battery is increased by a predetermined level or higher for a predetermined time period but the battery is not in a state of being charged through the generator of the vehicle, determining that it is an externally charged state attributable to an external charging device, obtaining a value of a charging current flowing through the battery during the externally charged state, and compensating the SOC of the battery based on the value of the charging current.

2. The method as set forth in claim 1, wherein whether the battery is charged through the generator of the vehicle is determined using a value of current flowing through a shunt of a battery sensor.

3. The method as set forth in claim 1, wherein the compensating the SOC of the battery is performed if it is determined that the battery is not in a discharged state, wherein the determination of whether the battery is in a discharged state is made using a value of current flowing through a shunt of a battery sensor.

4. The method as set forth in claim 1, wherein the value of the charging current is obtained based on a voltage of the battery measured before the voltage is increased, a voltage of the battery in the externally charged state, and an internal resistance of the battery.

5. The method as set forth in claim 1, wherein the compensating the SOC of the battery is terminated when the voltage of the battery is decreased by a predetermined level or higher for a predetermined time period.
